(19) United States
(12) Patent Application Publication
(10) Pub. No.: US 2011/0200014 A1
(43) Pub. Date: Aug. 18, 2011

(54) METHOD AND APPARATUS FOR DELIVERING MEASUREMENT RESULT INFORMATION IN MOBILE COMMUNICATION SYSTEM

(75) Inventors: Young Dae LEE, Buchen-si (KR); Sunghoon JUNG, Anyang-si (KR); SeungJune YI, Seoul (KR); SungDuck CHUN, Sungnam-si (KR); SungJun PARK, Anyang-si (KR)

(73) Assignee: LG ELECTRONICS INC.

(21) Appl. No.: 13/027,192

(22) Filed: Feb. 14, 2011

Related U.S. Application Data
(60) Provisional application No. 61/304,476, filed on Feb. 14, 2010.

(30) Foreign Application Priority Data
Feb. 8, 2011 (KR) 10-2011-0011177

(51) Int. Cl. H04W 36/00

(52) U.S. Cl. 370/332

(57) ABSTRACT

A method and apparatus for efficiently delivering measurement result information in a mobile communication system are disclosed. In an aspect of the present invention, a method for performing, by a serving base station, a handover operation in a mobile communication system, includes receiving a measurement report including a measurement result of at least one cell from a user equipment, determining handover based on the received measurement report, and upon determination of handover, transmitting a handover request message to a target base station, wherein the handover request message includes the measurement result of the at least one cell.

Pursuant to 35 U.S.C. §119, this application claims the benefit of earlier filing date and right of priority to Korean Application No. 10-2011-0011177, filed on Feb. 8, 2011, and U.S. Provisional Application Ser. No. 61/304,476, filed on Feb. 14, 2010, the contents of which are hereby incorporated by reference in their entirety.

### BACKGROUND OF THE INVENTION

1. Field of the Invention

The present invention relates to a method and apparatus for efficiently delivering measurement result information in a mobile communication system.

2. Discussion of the Related Art

A mobile communication system needs to support mobility of a user equipment (UE). To this end, the UE continues to measure quality of a serving base station (BS) and neighbor BSs. The UE reports the measurement results to a network at a proper time and the network provides optimal mobility to the UE through handover etc.

To provide information, which may be helpful for a service provider to operate a network, in addition to the purpose of supporting the mobility, the UE may perform measurement for a specific purpose determined by the network, and may report the measurement results to the network. For example, the UE may receive broadcast information of a specific cell determined by the network. The UE may then report a cell identity (also referred to as a global cell identity) of the specific cell, location identification information (e.g., a tracking area code) indicating a location of the specific cell, and/or other cell information (e.g., information representing whether the specific cell is a member of a closed subscriber group (CSG) cell) to the serving BS.

If a UE, which is in motion, determines through measurement that a specific region has extremely poor quality, the UE may report location information about cells with poor quality and a measurement result to the network. The network may attempt to optimize the network based on the measurement result reported from UEs which assist network operation.

In a mobile communication system having a frequency reuse factor of 1, mobility is generally supported between different cells having the same frequency band. To effectively guarantee mobility of the UE, therefore, the UE has to reliably measure quality and information of neighbor cells having the same center frequency as a center frequency of a serving BS. Such measurement of a cell having the same center frequency as the center frequency of the serving BS is referred to as intra-frequency measurement. The UE may perform intra-frequency measurement and may report a measurement result to the network at a proper time.

A mobile communication service provider may operate a network using a plurality of frequency bands. If a service of a communication system is provided through the plurality of frequency bands, the UE is guaranteed optimal mobility when the UE is able to reliably measure quality and information of neighbor cells having a different center frequency from the center frequency of the serving BS. Such measurement of a cell having the different center frequency from the center frequency of the serving BS is referred to as inter-frequency measurement. The UE may perform inter-frequency measurement and may report a measurement result to the network at a proper time.

When the UE supports measurement of a heterogeneous network, it may measure a cell of the heterogeneous network according to a configuration of a BS. Such measurement of the heterogeneous network is referred to as inter-radio access technology (RAT) measurement. For example, RAT may include a UMTS terrestrial radio access network (UTRAN) and a GMS/EDGE radio access network (GERAN) conforming to the 3GPP standard, and may also include a CDMA 2000 system conforming to the 3GPP2 standard.

Conventionally, however, a target BS may receive the measurement result of the target BS after performing a handover operation. That is, since the target BS has to additionally receive the measurement result from the UE after the handover operation is performed, high data rate communication may be hindered.

Especially, if a carrier aggregation scheme which performs simultaneous communication through a plurality of component carriers is applied to the UE, the target BS performs the handover operation only upon one component carrier, and again performs communication using a plurality of component carriers through a measurement result of the plurality of component carriers. Consequently, a time delay occurs and a method for solving this problem is needed.

### SUMMARY OF THE INVENTION

Accordingly, the present invention is directed to a method and apparatus for delivering measurement result information in a mobile communication system, that substantially obviate one or more problems due to limitations and disadvantages of the related art.

An object of the present invention is to provide a method and apparatus for delivering measurement result information to a serving BS or a target BS before a handover operation is performed in a mobile communication system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for performing, by a serving base station, a handover operation in a mobile communication system, includes receiving a measurement report including a measurement result of at least one cell from a user equipment, determining handover based on the received measurement report, and upon determination of handover, transmitting a handover request message to a target base station, wherein the handover request message includes the measurement result of the at least one cell.

The measurement result of the at least one cell may be included in a radio resource control (RRC) context information element of the handover request message.

The measurement result of the at least one cell may include a reference signal received power (RSRP) measurement result and a reference signal received quality (RSRQ) measurement result of the at least one cell.

The measurement result of the at least one cell may include a physical cell identifier of the at least one cell.

The handover request message may further include carrier frequency information.

The at least one cell may correspond to at least one component carrier which is aggregated.

In another aspect of the present invention, a method for performing, by a target base station, a handover operation in a mobile communication system, includes receiving a handover request message from a serving base station, and transmitting a handover request acknowledgement message to the serving base station, wherein the handover request message includes a measurement result of at least one cell received from a user equipment.

The measurement result of the at least one cell may be included in a radio resource control (RRC) context information element of the handover request message.

The measurement result of the at least one cell may include a reference signal received power (RSRP) measurement result and a reference signal received quality (RSRQ) measurement result of the at least one cell.

The measurement result of the at least one cell may include a physical cell identifier of the at least one cell.

The handover request message may further include carrier frequency information.

The at least one cell may correspond to at least one component carrier which is aggregated.

In still another aspect of the present invention, a method for performing, by a user equipment, a handover operation in a mobile communication system, includes configuring a measurement report including a measurement result of at least one cell, and transmitting the configured measurement report, wherein the measurement result of the at least one cell included in the measurement report is included in a handover request message and is transmitted to a target base station from a serving base station.

The measurement result of the at least one cell may be included in a radio resource control (RRC) context information element of the handover request message.

The measurement result of the at least one cell may include a reference signal received power (RSRP) measurement result and a reference signal received quality (RSRQ) measurement result of the at least one cell.

The measurement result of the at least one cell may include a physical cell identifier of the at least one cell.

The handover request message may further include carrier frequency information.

The at least one cell may correspond to at least one component carrier which is aggregated.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a structure of an evolved universal terrestrial radio access network (E-UTRAN) as an exemplary mobile communication system;

FIGS. 2 and 3 are views illustrating a structure of a radio interface protocol between a UE and an E-UTRAN, based on the 3GPP radio access network specification;

FIG. 4 is a view illustrating an operation related to radio link failure;

FIGS. 5 and 6 are views illustrating success and failure of an RRC connection re-establishment procedure, respectively;

FIG. 7 is a view illustrating a procedure of a UE for performing measurement and reporting a measurement result to a network in a 3GPP LTE system;

FIG. 8 illustrates an example of a measurement configuration assigned to a UE;

FIG. 9 illustrates an example of removing a measurement identity;

FIG. 10 illustrates an example of removing a measurement object;

FIG. 11 illustrates an example of obtaining measurement result information of a target BS by a serving BS before handover and transmitting the measurement result information to the target BS;

FIG. 12 illustrates a carrier aggregation scheme applied to a 3GPP LTE-A system;

FIG. 13 illustrates the definition of a cell in terms of a UE when a CA technique is applied;

FIG. 14 is a view illustrating an exemplary embodiment for a target BS to receive measurement results of a plurality of CCs prior to handover;

FIG. 15 a view illustrating another exemplary embodiment for a target BS to receive measurement results of a plurality of CCs prior to handover;

FIG. 16 is a view illustrating a radio communication system including a UE device and a BS device according to the present invention;

FIG. 17 illustrates the function of a BS processor, especially an L2 (a second layer) structure, to which the exemplary embodiments of the present invention are applied; and

FIG. 18 illustrates the function of a UE processor, especially an L2 (a second layer) structure, to which the exemplary embodiments of the present invention are applied.

### DETAILED DESCRIPTION OF THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. For example, although the following description assumes a 3GPP LTE based system as an example of a mobile communication system, it may have a wide variety of applications as a method for performing efficient measurement in various mobile communication systems to which a carrier aggregation technique may be applied, such as an IEEE 802.16 based system.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention. The same reference numbers will be used throughout this specification to refer to the same or like parts.

Hereinafter, a method and apparatus for a cell to efficiently transmit signal measurement information for a handover operation in a mobile communication system will be described. To this end, a brief description of a 3GPP LTE system will be given as an example of a mobile communication system to which the above-mentioned carrier aggregation technique is applied.

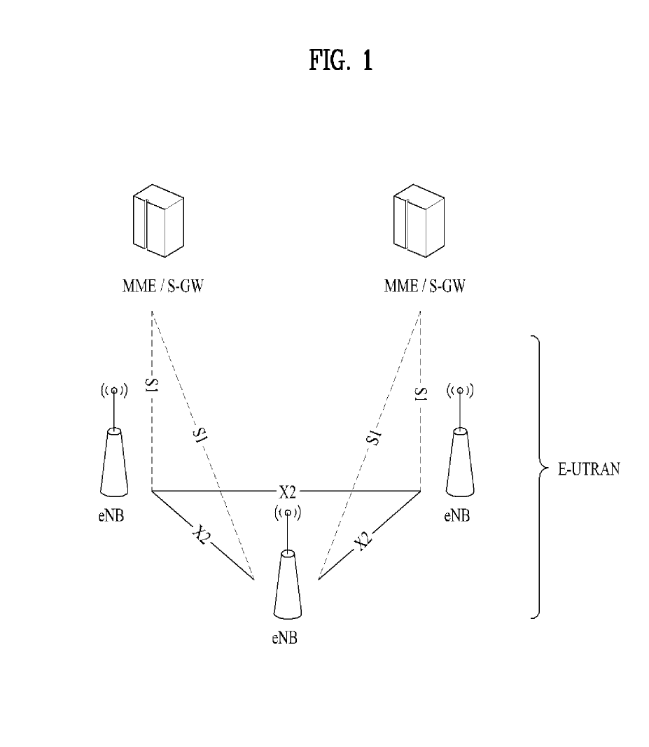

FIG. 1 illustrates a structure of an evolved universal terrestrial radio access network (E-UTRAN) as an exemplary mobile communication system. An E-UTRAN system has evolved from the existing UTRAN system, and basic standardization thereof is currently underway in 3GPP. The E-UTRAN system may also be referred to as a long term evolution (LTE) system.

The E-UTRAN includes a plurality of eNBs (e-NodeBs or BSs), and the plurality of eNBs are connected to one another through an X2 interface. The eNB is connected to a UE through a radio interface and is connected to an evolved packet core (EPC) through an S1 interface.

The EPC includes a mobility management entity (MME), a serving-gateway (S-GW), and a packet data network-gateway (PDN-GW). The MME contains access or capability information of a UE which is primarily used for mobility management of the UE. The S-GW is a gateway having the E-UTRAN as an end point, and the PDN-GW is a gateway having a PDN as an end point.

The radio interface protocol layers between a UE and a network may be divided into a first layer (L1), a second layer (L2) and a third layer (L3) based on the three lower layers of an open system interconnection (OSI) reference model widely known in communication systems. A physical layer belonging to the first layer provides information transfer services using a physical channel. A Radio Resource Control (RRC) layer located at the third layer controls radio resources between the UE and the network, and to this end, the RRC layer exchanges RRC messages between the UE and the network.

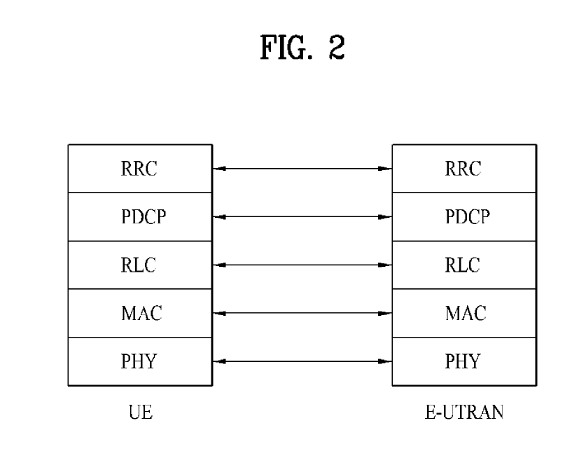

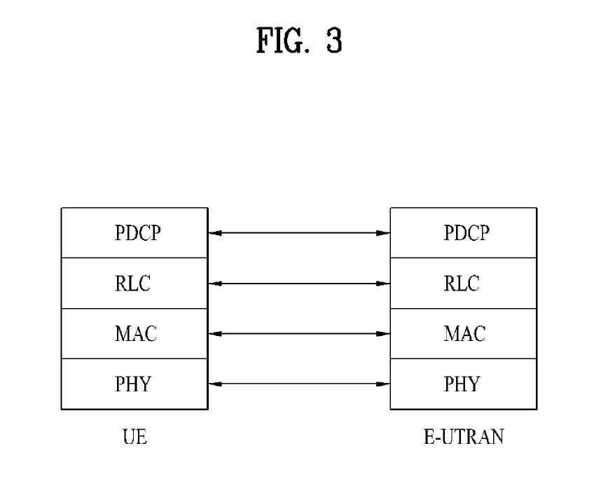

FIGS. 2 and 3 illustrate a structure of a radio interface protocol between a UE and an E-UTRAN, based on the 3GPP radio access network specification.

The radio interface protocol horizontally includes a physical layer, a data link layer and a network layer, and, is vertically divided into a user plane (U-plane) for transmitting data information and a control plane (C-plane) for transmitting a control signaling. The protocol layers of FIGS. 2 and 3 may be divided into a first layer (L1), a second layer (L2) and a third layer (L3) based on the three lower layers of an OSI reference model widely known in communications systems. Each radio protocol layer in the UE is paired with that in the E-UTRAN to transmit data for a radio section.

Hereinafter, each layer in a radio protocol C-plane of FIG. 2 and a radio protocol U-plane of FIG. 3 will be described.

The physical layer, which is the first layer, provides an information transfer service to an upper layer using a physical channel. The physical layer is connected to a medium access control (MAC) layer of an upper layer via a transport channel, and data between the MAC layer and the physical layer is transferred through the transport channel. Data between different physical layers, that is, between the physical layer of a transmitting side and the physical layer of a receiving side is transferred via the physical channel. The physical channel is modulated by an orthogonal frequency division multiplexing (OFDM) scheme and utilizes time and frequency as radio resources.

The MAC layer, which is the second layer, provides service to a Radio Link Control (RLC) layer of an upper layer via a logical channel. The RLC layer, which is the second layer, supports reliable data transmission. The function of the RLC layer may be implemented as a functional block in the MAC layer. In this case, the RLC layer may be no longer necessary. A packet data convergence protocol (PDCP) layer, which is the second layer, performs a header compression function for reducing the size of an IP packet header, which is relatively large in size and includes unnecessary control information, in order to efficiently transmit IP packets, such as IPv4 or IPv6, in a radio section having a relatively small bandwidth.

An RRC layer located at the uppermost portion of the third layer is defined only in the C-plane. The RRC layer controls logical channels, transport channels and physical channels in relation to the configuration, re-configuration and release of radio bearers (RBs). Here, the RBs denote services provided by the second layer to perform data transmission between a UE and a UTRAN. If an RRC connection is established between an RRC layer of the UL and an RRC layer of a radio network, then the UE is in an RRC connected state (RRC_CONNECTED). Otherwise, the UE is in an RRC idle state (RRC_IDLE).

Downlink transport channels for transmitting data from a network to a UE may include a broadcast channel (BCH) for transmitting system information, and a downlink shared channel (SCH) for transmitting user traffic or control messages. Traffic or control messages of a downlink multicast or broadcast service may be transmitted via either a downlink SCH or a separate downlink multicast channel (MCH). Meanwhile, uplink transport channels for transmitting data from a UE to a network include a random access channel (RACH) for transmitting an initial control message and an uplink SCH for transmitting user traffic or control messages.

Logical channels, which are located at an upper level of transport Channels and are mapped to the transport channels, include a broadcast control channel (BCCH), a paging control channel (PCCH), a common control channel (CCCH), a multicast control channel (MCCH), a multicast traffic channel (MTCH), and the like.

A physical channel includes multiple sub-frames arranged on a time axis and multiple sub-carriers arranged on a frequency axis. Here, one sub-frame includes a plurality of symbols on the time axis. One sub-frame includes a plurality of resource blocks each including a plurality of symbols and a plurality of sub-carriers. Each sub-frame may use specific sub-carriers of specific symbols (e.g., the first symbol) in the corresponding sub-frame for a Physical Downlink Control Channel (PDCCH), that is, an L1/L2 control channel. A sub-frame may include two slots each having a time duration of 0.5 ms and may correspond to a Transmission Time Interval (TTI), as a unit time for transmitting data, which is 1 ms.

Next, system information will be described. The system information includes essential information necessary for the UE to access a BS. Therefore, the UE should have received all of the system information prior to accessing the BS, and should also have the latest system information all the time. Since the system information should be known to all UEs in a cell, the BS periodically transmits the system information.

The system information is divided into a master information block (MIB), a scheduling block (SB), a system information block (SIB), etc. The MIB allows the UE to be notified of a physical configuration of an associated cell, for example, a bandwidth and the like. The SB allows the UE to be notified of the transmission information of SIBs, for example, a transmission period and the like. The SIB is a set of mutually-related system information. For example, a certain SIB includes only the information of neighbor cells, and another certain SIB includes only the information of uplink radio channels used by the UE.

Meanwhile, services provided by the network to the UE may be divided into three types. The UE differently recognizes the type of a cell based on which service can be received. First, the type of services will be described, and then the type of a cell will be described below.

1) Limited service: This service provides an emergency call and an earthquake and tsunami warning service (ETWS), and may be provided by an acceptable cell.

2) Normal service: This service refers to a public use with general purposes, and may be provided by a suitable cell.

3) Operator service: This service refers to a service for communication network service providers. A cell may be used only by communication network service providers and may not be used by general users.

With regard to the service types provided by cells, cells may be divided into the following types.

1) Acceptable cell: A cell in which the UE may receive a limited service. This cell is not barred and satisfies the cell selection criteria of the LIE from a standpoint of the corresponding UE.

2) Suitable cell: A cell in which the UE may receive a normal service. This cell satisfies the condition of an acceptable cell and simultaneously satisfies additional conditions. For additional conditions, the cell should belong to a public land mobile network (PLMN) which may be accessed by the corresponding UE and should not bar a tracking area update procedure implemented by the UE. If the corresponding cell is a CSG cell, then it should be a cell that may be accessed by the UE as a CSG member.

3) Barred cell: A cell which broadcasts information representing that it is a barred cell through the system information.

4) Reserved cell: A cell which broadcasts information representing that it is a reserved cell through the system information.

Hereinafter, an RRC state and an RRC connection method of a UE will be described in detail. The RRC state refers to whether the RRC of the UE is logically connected to the RRC of an E-UTRAN. If it is connected, this is called an RRC_CONNECTED state, and otherwise this is called an RRC_IDLE state. For the UE in an RRC_CONNECTED state, the E-UTRAN may recognize the presence of the corresponding UE in a cell unit because there exists an RRC connection, and thus the E-UTRAN may effectively control the UE. On the contrary, for the UE in an RRC_IDLE state, the E-UTRAN may not recognize the corresponding UE, and therefore, the UE is managed by a core network in a tracking area unit, which is a unit larger than a cell. Namely, only the presence/absence of the UE in an RRC_IDLE state is recognized in a large area unit, and the UE should change to an RRC_CONNECTED state in order to receive typical mobile communication services such as voice or data services.

When the UE is initially turned on by a user, the UE first searches for a suitable cell and then maintains an RRC_IDLE state in the corresponding cell. The UE in the RRC_IDLE state establishes an RRC connection with the RRC of the E-UTRAN through an RRC connection procedure when there is a need to establish an RRC connection, thereby transitioning to an RRC_CONNECTED state. There are several cases where the UE an idle state needs to establish an RRC connection. For example, uplink data transmission may be needed due to a phone call attempt by the user, or the transmission of a response message may be required in response to a paging message received from the E-UTRAN.

A Non-Access Stratum (NAS) layer located at an upper level of the RRC layer performs functions such as session management, mobility management, etc.

In order to manage the mobility of the UE at the (NAS) layer, both an EPS mobility management-registered (EMM-REGISTERED) state and an EMM-DEREGISTERED state are defined, and both states are applied to the UE and a mobility management entity (MME). The UE is initially in an EMM-DEREGISTERED state, and performs a process of registering with the corresponding network through an initial attach procedure in order to access a network. If the attach procedure has been successfully performed, then the UE and the MME enter an EMM-REGISTERED state.

In order to manage a signaling connection between the UE and the EPC, both an EPS connection management (ECM)-IDLE state and an ECM-CONNECTED state are defined, and both states are applied to the UE and the MME. If the UE in an ECM-IDLE state makes an RRC connection with an E-UTRAN, then the UE is in an ECM-CONNECTED state. If the MME in an ECM-IDLE state makes an S1 connection with an E-UTRAN, then the MME is in an ECM-CONNECTED state. When the UE is in an ECM-IDLE state, the E-UTRAN has no context information of the UE. Accordingly, the UE in an ECM-IDLE state carries out a UE-based mobility procedure such as cell selection or reselection without receiving a command from the network. On the contrary, when the UE is in an ECM-CONNECTED state, the mobility of the UE is managed by a command from the network. If the location of the UE in an ECM-IDLE state is changed from the location that has been recognized by the network, the UE informs the network of the location of the UE through a tracking area update procedure.

Meanwhile, a radio link failure procedure in a 3GPP LTE system will be described.

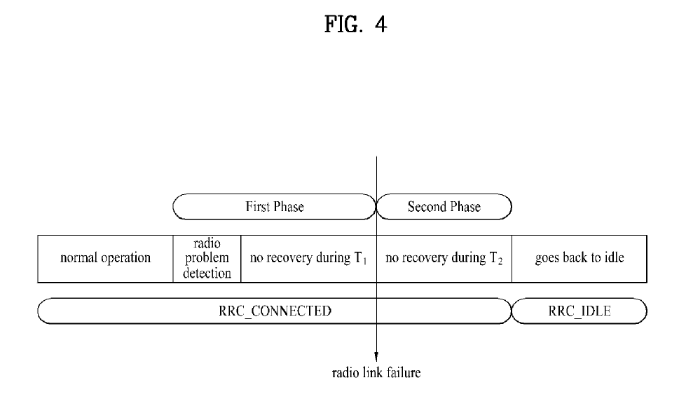

A UE persistently performs measurement to maintain the quality of a communication link with a serving cell from which the UE receives a service. Especially, the UE determines whether the quality of the communication link with the serving cell is a communication impossible state. If it is determined that the quality of the serving cell is so poor that communication is almost impossible, the UE declares radio link failure. If the radio link failure is declared, the UE gives up maintaining communication with the current serving cell, selects a new cell through a cell selection procedure, and attempts RRC connection re-establishment to the new cell. An operation related to radio link failure may be described by two phases as shown in FIG. 4.

In the first phase, a UE determines whether a current communication link is problematic. If it is problematic, the UE declares a radio link problem, and waits for recovery of the communication link during a prescribed time T1. If the communication link is recovered before the expiry of the time T1, the UE continues to perform a normal operation. If the radio link problem is not recovered until the time T1 expires, the UE declares radio link failure and enters the second phase. In the second phase, the UE performs an RRC re-establishment procedure for recovery of the communication link after radio link failure.

The RRC connection re-establishment procedure is a procedure for re-establishing an RRC connection in an RRC_CONNECTED state. Since the UE remains in the RRC_CONNECTED state, that is, the UE does not enter an RRC_IDLE state, the UE does not initialize all radio configurations (e.g., radio bearer configuration). Instead, when the RRC connection re-establishment procedure is started, the UE temporarily suspends the use of other radio bearers except for a signaling radio bearer 0 (SRBO). If RRC connection re-establishment is successful, the UE resumes the use of radio bearers of which use is temporarily suspended.

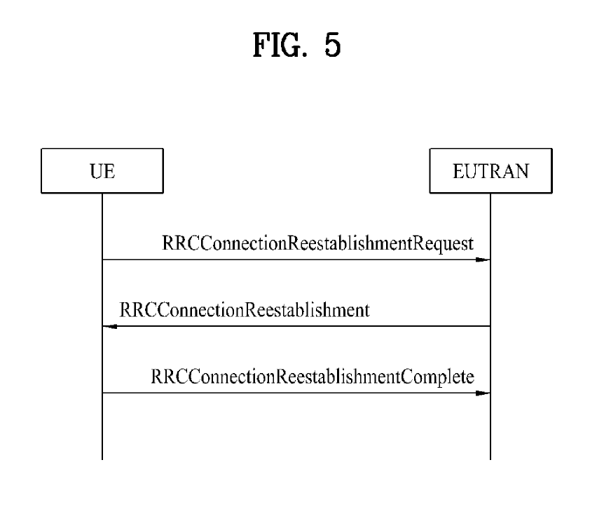

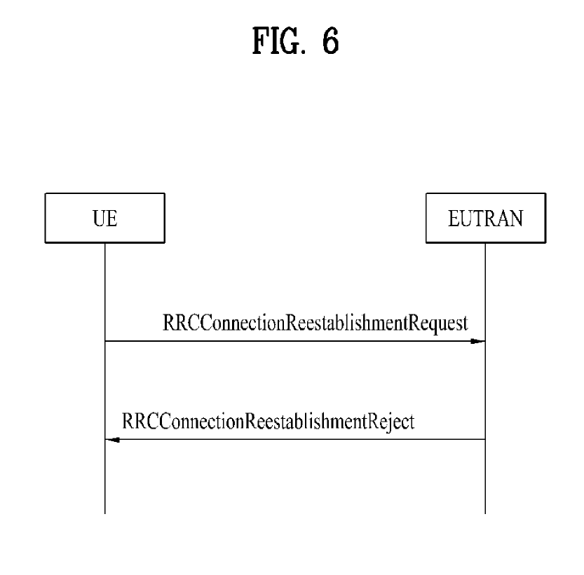

FIGS. 5 and 6 illustrate success and failure of an RRC connection re-establishment procedure.

An operation of the UE in the RRC re-establishment procedure is described with reference to FIGS. 5 and 6. A UE performs cell selection to select one cell. The UE receives system information to receive basis parameters for cell access from the selected cell. Then, the UE attempts RRC connection re-establishment through a random access procedure. If the selected cell is a cell having the context of the UE, i.e., a prepared cell, the relevant cell may accept an RRC connection re-establishment request by the UE, and thus the RRC connection re-establishment procedure may be successful. However, if the selected cell is not a prepared cell, since the relevant cell has no context of the UE, an RRC connection re-establishment request by the UE is rejected. Accordingly, the RRC connection re-establishment procedure fails.

Hereinafter, a measurement procedure in a 3GPP LTE system will be described.

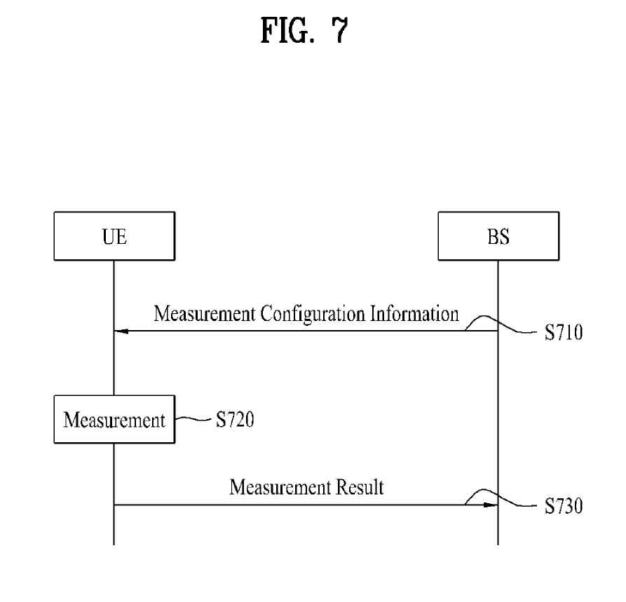

FIG. 7 is a view illustrating a procedure of a UE for performing measurement and reporting a measurement result to a network in a 3GPP LTE system.

A UE receives measurement configuration information from a BS (step S710). A message including the measurement configuration information is referred to as a measurement configuration message. The UE performs measurement based on the measurement configuration information (step S720). If a measurement result satisfies a reporting condition included in the measurement configuration information, the UE reports the measurement result to the BS (step S730). A message including the measurement result is referred to as a measurement report message.

The measurement configuration information may include the following information.

(1) Measurement object information: This information denotes an object that the UE measures. The measurement object includes at least one of an intra-frequency measurement object which is an object of intra-frequency measurement, an inter-frequency measurement object which is an object of inter-frequency measurement, and an inter-RAT measurement object which is an object of inter-RAT measurement. For example, the intra-frequency measurement object may indicate a neighbor cell having the same frequency band as a frequency band of a serving cell, the inter-frequency measurement object may indicate a neighbor cell having a different frequency band from a frequency band of the serving cell, and the inter-RAT measurement object may indicate a neighbor cell of a different RAT from an RAT of the serving cell.

(2) Reporting configuration information: This information denotes a reporting condition and a reporting type regarding when the UE reports a measurement result. The reporting condition may include information on a period or an event for triggering reporting of the measurement result. The reporting type is information indicating a particular type according to how to configure the measurement result.

(3) Measurement identity information: This information denotes a measurement identifier for determining when the UE will report measurement with respect to any measurement object by associating the measurement object with a reporting configuration, and which type of reporting is used by UE. The measurement identity information may be included in the measurement report message to indicate which measurement object the measurement result is about and which reporting condition was used.

(4) Quantity configuration information: This information denotes a measurement unit, a reporting unit, and/or a parameter for determining filtering of a measurement result value.

(5) Measurement gap information: This information denotes a measurement gap which is a duration that may be used by the UE only for measurement without any consideration of data transmission to a serving cell when downlink transmission or uplink transmission is not scheduled.

To perform a measurement procedure, the UE has a measurement object list, a measurement reporting configuration list, and a measurement identity list.

In 3GPP LTE, the BS may assign only one measurement object to the UE with respect to one frequency band. Events for triggering measurement reporting shown in the table below are defined in section 5.5.4 of 3GPP TS 36.331 V8.5.0 (2009-03) “Evolved Universal Terrestrial Radio Access (E-UTRA) Radio Resource Control (RRC); Protocol specification (Release 8)”.

TABLE 1

| EVENT | REPORTING CONDITION |
|---|---|
| Event A1 | Serving becomes better than threshold |
| Event A2 | Serving becomes worse than threshold |
| Event A3 | Neighbour becomes offset better than serving |
| Event A4 | Neighbour becomes better than threshold |
| Event A5 | Serving becomes worse than threshold1 and |
| | neighbour becomes better than threshold2 |
| Event B1 | Inter RAT neighbour becomes better than threshold |
| Event B2 | Serving becomes worse than threshold1 and inter |
| | RAT neighbour becomes better than threshold2 |

If the measurement result of the UE satisfies the determined event, the UE transmits a measurement report message to the BS.

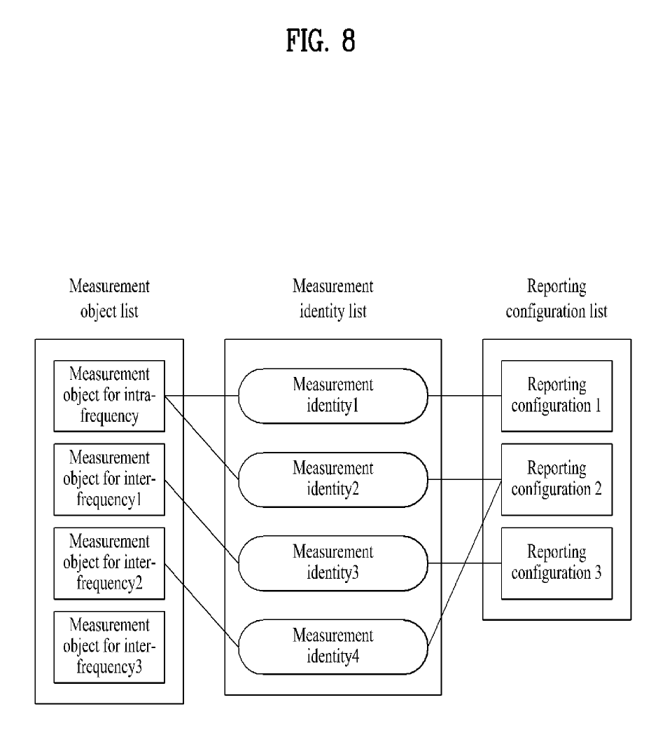

FIG. 8 illustrates an example of a measurement configuration assigned to a UE. First, a measurement identity 1 associates an intra-frequency measurement object with a reporting configuration 1. The UE performs intra-frequency measurement. The reporting configuration 1 is used to determine a reporting type and a criterion for reporting a measurement result.

A measurement identity 2 is associated with the intra-frequency measurement object similarly to the measurement identity 1 but associates the intra-frequency measurement object with a reporting configuration 2. The UE performs intra-frequency measurement. The reporting configuration 2 is used to determine a reporting type and a criterion for reporting a measurement result.

By the measurement identity 1 and the measurement identity 2, the UE may transmit a measurement result to a network even if the measurement result of the intra-frequency measurement object satisfies any one of the reporting configuration 1 and the reporting configuration 2.

A measurement identity 3 associates an inter-frequency measurement object 1 with a reporting configuration 3. If a measurement result of the inter-frequency measurement object 1 satisfies a reporting condition included in the reporting configuration 3, the UE may report the measurement result to the network.

A measurement identity 4 associates an inter-frequency measurement object 2 with the reporting configuration 2. When a measurement result on the inter-frequency measurement object 2 satisfies a reporting condition included in the reporting configuration 2, the UE may report the measurement result to the network.

Meanwhile, the measurement object, the reporting configuration, and/or the measurement identity may be added, modified and/or removed, by transmitting a new measurement configuration message or a measurement configuration modification message to the UE by the BS.

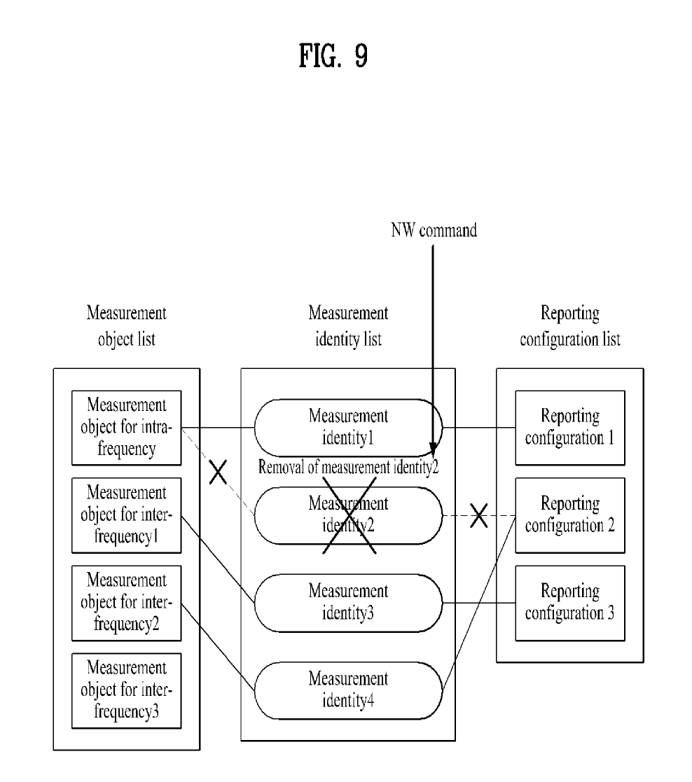

FIG. 9 illustrates an example of removing a measurement identity.

In FIG. 9, “NW command” may be a measurement configuration message or a measurement configuration modification message instructing a UE to remove a measurement identity 2. When the measurement identity 2 is removed, measurement of a measurement object associated with the measurement identity 2 is stopped, and a measurement report is not transmitted. However, a measurement object or a reporting configuration associated with the removed measurement identity may not be modified.

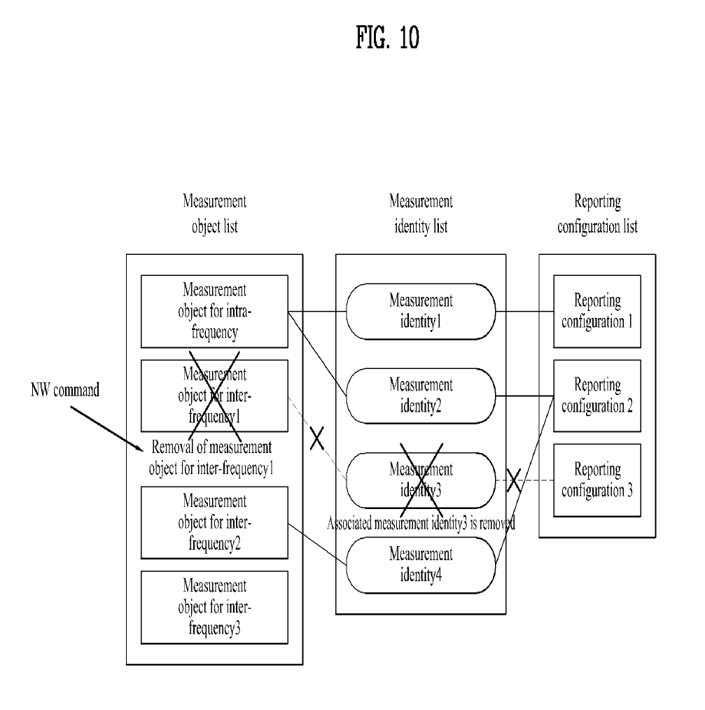

FIG. 10 illustrates an example of removing a measurement object.

In FIG. 10, “NW command” may be a measurement configuration message or a measurement configuration modification message instructing a UE that an inter-frequency measurement object 1 be removed. If the inter-frequency measurement object 1 is removed, the UE may also remove a measurement identify 3 associated therewith. Measurement of the inter-frequency measurement object 1 is stopped, and a measurement report may not be transmitted. However, a reporting configuration associated with the removed inter-frequency measurement object 1 may not be modified or removed.

When the reporting configuration is removed, the UE also removes an associated measurement identity. The UE suspends measurement reporting and measurement of an associated measurement object according to the associated measurement identity. However, a measurement object associated with the removed reporting configuration may not be modified or removed.

Meanwhile, in order to support the mobility of the UE or for a specific purpose established by a network, a method for performing, by the UE, measurement and reporting a measurement result to a serving BS have been conventionally used. However, since a target BS receives the measurement result thereof after handover, smooth communication is hindered.

Accordingly, an exemplary embodiment of the present invention provides a method for ensuring smooth communication after handover, in which the serving BS obtains information including a measurement result on the target BS from the UE before handover and transmits a handover request message including the received measurement result to the target BS.

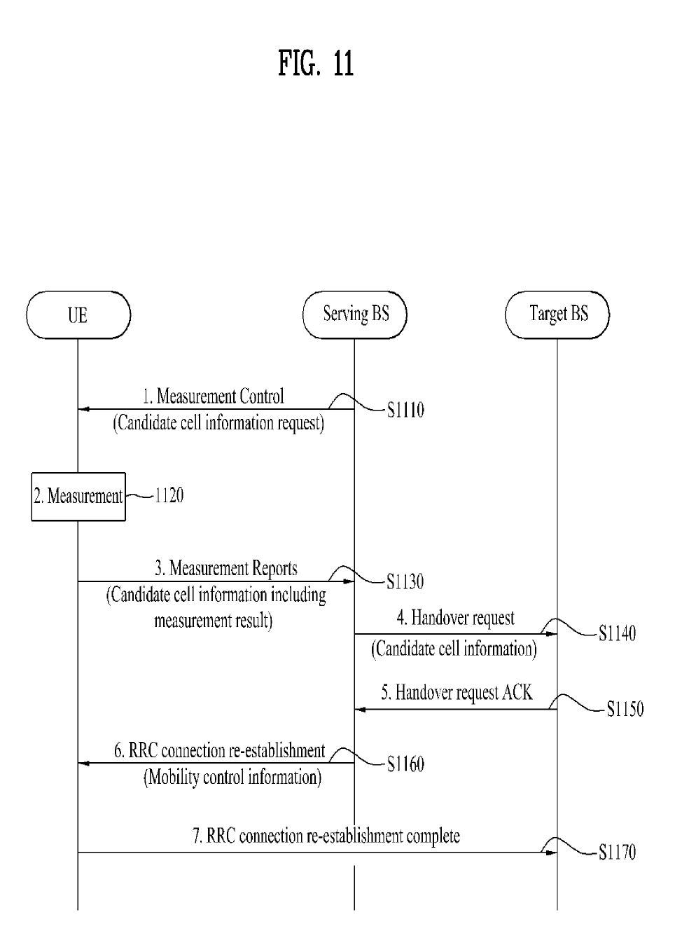

FIG. 11 illustrates an example of obtaining measurement result information on a target BS by a serving BS before handover and transmitting the measurement result information to the target BS.

The serving BS requests a UE to perform measurement (step S1110). The serving BS may request various types of measurement as described above. That is, the serving BS may request the UE to perform measurement of quality of the serving BS and neighbor cells in order to support the mobility of the UE, measurement of information which is necessary to communicate with neighbor cells, and measurement of a specific purpose to assist a service provider in network operation.

The UE performs measurement (step S1120) and transmits a measurement result to the serving BS (step S1130).

For convenience of description, information including the measurement result will be referred to as candidate BS information, and it is assumed that the candidate BS information includes a measurement result requested with respect to at least one candidate BS.

Upon receiving the candidate BS information, the serving BS transmits a handover request message to the target BS together with the candidate BS information (S1140).

Here, the candidate BS information transmitted to the target BS may be information including only the measurement result on the target BS.

Then the target BS may previously obtain the measurement result of the target BS before a handover operation is carried out. The target BS transmits a handover request acknowledgment (ACK) message to the serving BS (step S1150).

Next, the serving BS transmits an RRC connection re-establishment message including mobility control information to the UE (step S1160). The UE transmits an RRC connection re-establishment complete message to the target BS (step S1170).

Thus, the target BS may rapidly transmit and receive data using the candidate BS information received together with the handover request message in step S1140, without an additional measurement request or reception of the measurement result value after handover, thereby ensuing UE mobility.

According to section 10.3 of 3GPP TS 36.331 CR 488 rev 1 V9.4.0 (2010-11), a measurement result reported before handover is summarized as shown in Table 2 below.

TABLE 2
RRM-Config
The RRM-Config IE contains information about UE specific RRM information before the
handover which can be utilized by target eNB.
RRM-Config information element
-- ASN1START
RRM-Config ::= SEQUENCE {

| | |
|---|---|
| ue-InactiveTime | ENUMERATED { |

```
                                  s1, s2, s3, s5, s7, s10, s15, s20,
                                  s25, s30, s40, s50, min1, min1s20c, min1s40,
                                  min2, min2s30, min3, min3s30, min4, min5, min6,
                                  min7, min8, min9, min10, min12, min14, min17, min20,
                                  min24, min28, min33, min38, min44, min50, hr1,
                                  hr1min30, hr2, hr2min30, hr3, hr3min30, hr4, hr5, hr6,
                                  hr8, hr10, hr13, hr16, hr20, day1, day1hr12, day2,
                                  day2hr12, day3, day4, day5, day7, day10, day14, day19,
                                  day24, day30, dayMoreThan30} OPTIONAL,
```

| | |
|---|---|
| ..., | |
| candidateCInfoList-r10 | CandidateCellInfoList-r10 OPTIONAL --Need/cond FFS |
| } | |
| CandidateCellInfoList-r10 ::= | SEQUENCE (SIZE (1..maxfreq)) OF CandidateCellInfo-r10 |
| CandidateCellInfo-r10 ::= | SEQUENCE { |
| -- cellIdentification | |

| | |
|---|---|
| physCellId-r10 | PhysCellId, |
| dl-CarrierFreq-r10 | ARFCN-ValueEUTRA, |

-- available measurement results

| | |
|---|---|
| rsrpResult-r10 | RSRP-Range OPTIONAL, |
| rsrqResult-r10 | RSRQ-Range OPTIONAL, |
| ... | |
| } | |
| -- ASN1STOP | |

As shown in Table 2, the measurement result may include an RSRP measurement result or an RSRQ measurement result of each candidate BS and may include a physical cell ID of each candidate BS and carrier frequency information. However, the present invention is not limited thereto and various types of measurement results may be transmitted to the serving BS or the target BS.

Further, the above-described mechanism for transmitting the candidate BS information to the target BS prior to handover assumes that the number of serving BSs is one, and may be applied to the case where the UE simultaneously performs communication through a plurality of component carriers as in the case where a carrier aggregation scheme is applied. Before a description thereof, the carrier aggregation scheme will be described.

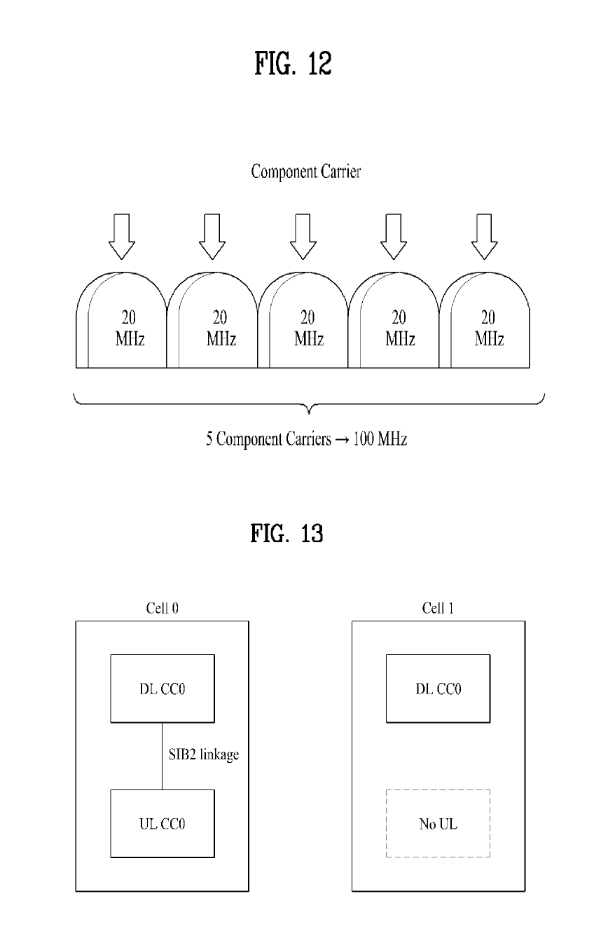

FIG. 12 illustrates a carrier aggregation scheme applied to a 3GPP LTE-A system.

LTE-A is the candidate for international telecommunication union (ITU) IMT-advanced technologies and is designed to conform to the technical requirements of the ITU IMT-Advanced. To meet these technical requirements, extension of a bandwidth in LTE-A relative to the existing LTE system has been under discussion. To extend the bandwidth in the LTE-A system, a carrier in the conventional LTE system is defined as a component carrier (CC), and use of groups of up to 5 CCs is being discussed. Since a CC may have a bandwidth of up to 20 MHz as in the LTE system, it may extend a bandwidth up to 100 MHz. Using multiple CCs in groups is referred to as carrier aggregation (CA).

FIG. 13 illustrates the definition of a cell in terms of a UE when a CA technique is applied.

As described in conjunction with FIG. 12, when CA is applied, a plurality of CCs may be included in each of downlink (DL) and uplink (UL). In this system, from the point of view of a UE, a combination of DL CCs and UL CCs (cell 0 in FIG. 13) or DL CCs only (cell 1 in FIG. 13) may be regarded as a cell. As shown in FIG. 13, a linkage relationship between the DL CCs and UL CCs may be indicated by system information transmitted through DL resources. Namely, system information of a mobile communication system to which CA is applied further includes information on the linkage relationship between the UL CCs and DL CCs in addition to the above-described system information. In FIG. 13, the information on the linkage relationship is shown as an SIB2 linkage.

Meanwhile, in the LTE-A system, there is proposed the concept that CCs through which all control signaling is transmitted are referred to as primary CCs to distinguish them from other CCs. UL primary CCs and DL primary CCs are configured per UE. Combinations of UL primary CCs, used to transmit UL control information, and DL primary CCs, used to transmit DL control information, may be referred to as primary cells or PCells. Cells configured for the UE except for the primary cells or PCells may be referred to as secondary cells or SCells.

As described above, in a mobile communication system to which CA is applied, since the UE may simultaneously communicate with Pcells and Scells, the UE may have a plurality of serving cells.

The plurality of serving cells may be generally referred to interchangeably as cells or CCs. However, since a serving BS or a target BS in a mobile communication system may be referred to as a cell, each of a plurality of serving BSs to which CA is applied will hereinafter be referred to as a CC in order to prevent confusion.

In the prior art, when a CA scheme in which communication is simultaneously performed through a plurality of CCs is applied to a UE, a target BS performs a handover operation with respect to only one CC and then resumes communication with respect to the plurality CCs through measurement results of the plurality of CCs. As a result, a communication time is delayed.

Accordingly, the mechanism to transmit candidate BS information to a target BS before a handover operation is performed is applied to the present invention. That is, the present invention provides a method for transmitting, to a target BS, candidate BS information including a measurement result value of each of a plurality of component carriers prior to handover.

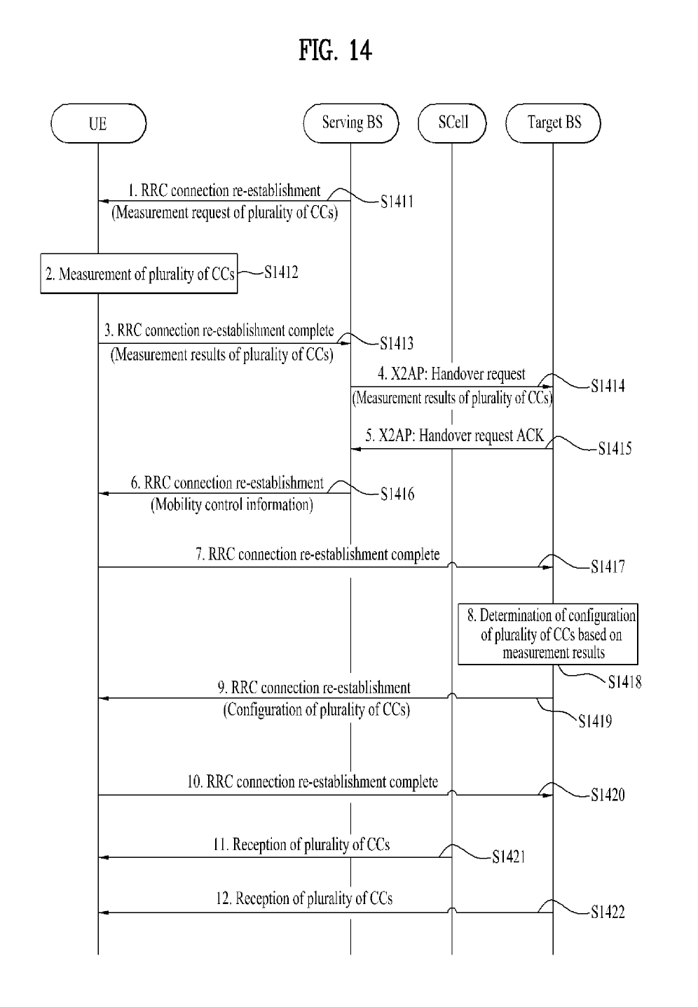

FIG. 14 is a view illustrating an exemplary embodiment for a target BS to receive measurement results of a plurality of CCs prior to handover.

A serving BS requests a UE to perform measurement of a plurality of CCs applied to the UE while transmitting an RRC connection re-establishment message to the UE (step S1411). The request for measurement may include various types of requests for measurement of a serving BS or neighbor BSs, which will be omitted for simplicity of the specification because a description has been given above.

The UE performs measurement of a plurality of CCs in response to the measurement request (step S1412). The UE transmits an RRC connection re-establishment complete message to the serving BS together with measurement results of the plurality of CCs (step S1413).

Upon receiving the measurement results of the plurality of CCs, the serving BS transmits a handover request message to a target BS together with the received measurement results (step S1414).

In this case, the transmitted measurement results may include only measurement results of the plurality of CCs with respect to the target BS.

Accordingly, the target BS may obtain the measurement results of the plurality of CCs and then transmit a handover request ACK message to the serving BS (step S1415).

Upon receiving the handover request ACK message, the serving BS transmits, to the UE, a RRC connection re-establishment message including mobility control information (step S1416).

The UE transmits an RRC connection re-establishment complete message to the target BS (step S1417). The target BS determines the configuration of a plurality of CCs through which data is to be transmitted and received, based on the measurement results of the plurality of CCs obtained in step S1414 (step S1418).

The target BS transmits, to the UE, an RRC connection re-establishment message including the configuration of the plurality of CCs (step S1419). The UE transmits an RRC connection re-establishment complete message to the target BS (step S1420).

The UE then transmits and receives data through the configured CCs (steps S1421 and S1422).

That is, the target BS receives measurement results prior to handover, without newly receiving measurement results of a plurality of other CCs after handover, thereby performing rapid communication through a plurality of CCs.

According to another exemplary embodiment of the present invention, another method is provided for transmitting, to a target BS, measurement results of a plurality of CCs prior to handover.

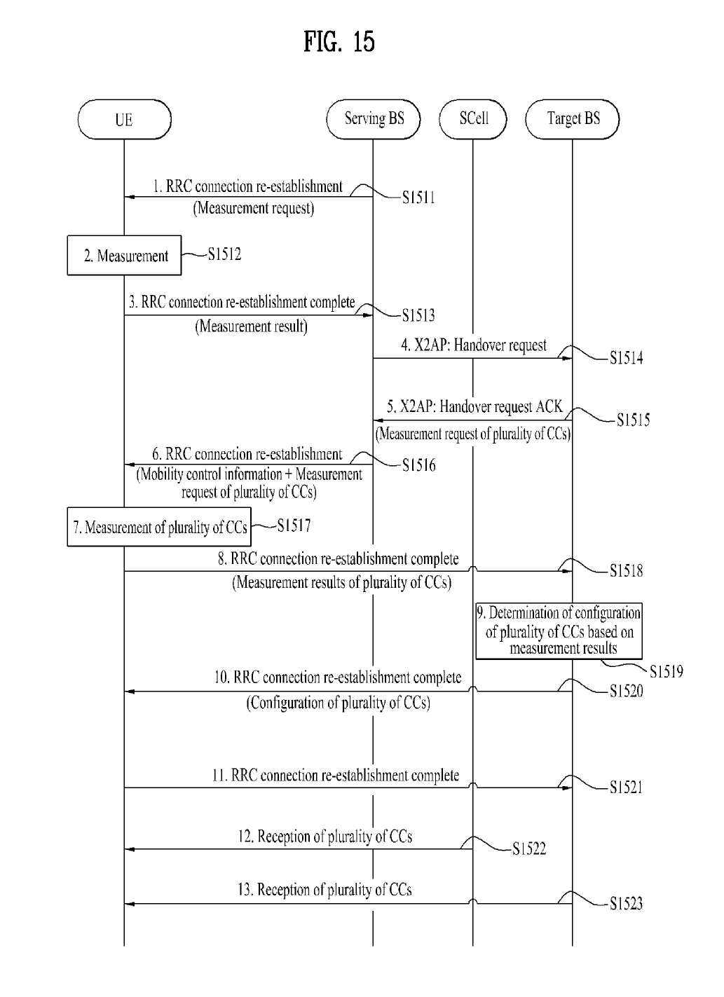

FIG. 15 is a view illustrating another exemplary embodiment for a target BS to receive measurement results of a plurality of CCs prior to handover.

A serving BS requests a UE to perform measurement while transmitting an RRC connection re-establishment message to the UE (step S1511). The request does not include measurement of a plurality of CCs unlike the request in FIG. 14.

The UE performs measurement in response to the measurement request (step S1512). The UE transmits an RRC connection re-establishment complete message to the serving BS together with a measurement result (step S1513).

The serving BS transmits a handover request message to a target BS (step S1514). The target BS requests the serving BS to perform measurement of a plurality of CCs while transmitting a handover request ACK message to the serving BS (S1515).

Upon receiving the request for measurement, the serving BS transmits, to the UE, an RRC connection re-establishment message including the request for measurement of the plurality of CCs and mobility control information (step 1516).

The UE performs measurement of the plurality of CCs (step S1517), and transmits an RRC connection re-establishment complete message including measurement results of the plurality of CCs to the target BS (step S1518).

The target BS determines the configuration of a plurality of CCs through which data is to be transmitted and received, based on the measurement results of the plurality of CCs (step S1519).

Steps 1520 to S1523 after the plurality of CCs is established are similar to steps S1419 to S1422 and therefore description thereof is omitted.

Through the method shown in FIG. 14 or 15, the target BS receives measurement results of a plurality of CCs before a handover operation is performed and thus rapid communication may be carried out.

Hereinafter, a UE device and a BS device for performing the above-described mechanism will be described.

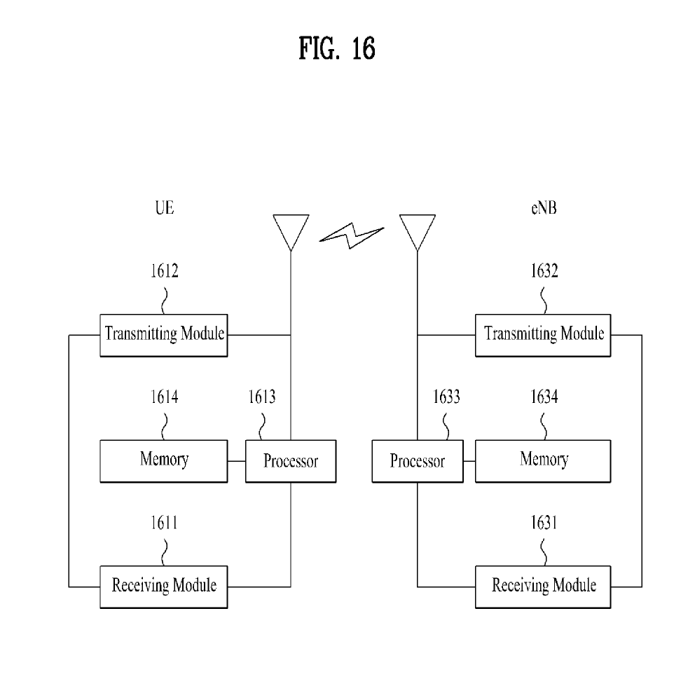

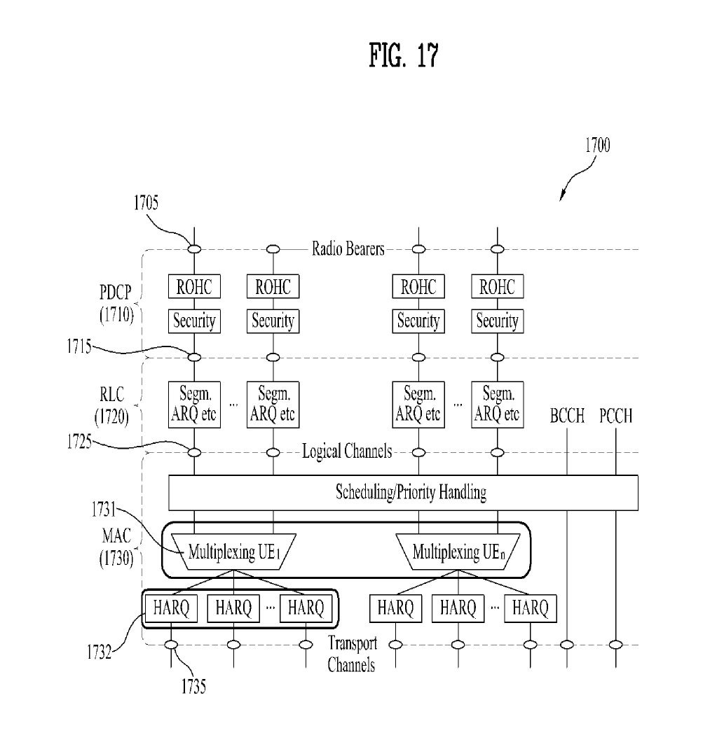

FIG. 16 is a view illustrating a radio communication system including a UE device and a BS device according to the present invention.

The UE device includes a receiving module 1611, a transmitting module 1612, a processor 1613, and a memory 1614. The receiving module 1611 receives signals, data, information, etc. from the BS device. The transmitting module 1612 transmits signals, data, information, etc. to the BS device. The receiving module 1611 receives the above-described measurement request information necessary for handover from a network. The processor 1613 controls a channel quality measurement operation performed according to a measurement request received through the receiving module 1611. Specifically, the processor 1613 transmits candidate BS information which includes a measurement result of a candidate BS, necessary for the UE to perform handover, to a serving BS prior to handover, so that efficient handover may be carried out.

The BS device includes a receiving module 1631, a transmitting module 1632, a processor 1633, and a memory 1634. The receiving module 1631 receives signals, data, information, etc. from the UE device. The transmitting module 1632 transmits signals, data, information, etc. to the UE device.

The processor 1633 controls the transmitting module 1632 to transmit configuration information for a specific CC among a plurality of CCs to the UE and manages the mobility of a relevant UE through a measurement report message received by the receiving module 1631 from the UE device. The processor 1633 transmits candidate BS information which includes a measurement result of a candidate BS, necessary for handover, to a target BS prior to handover. The processor 1633 performs an operation processing function of information received by the UE device, information to be externally transmitted, and the like. The memory 1634 stores the processed information for a prescribed time period and may be replaced with an element such as a buffer (not shown).

A configuration of the processor, which is a core of each of the above-described UE device and BS device, will be described in detail.

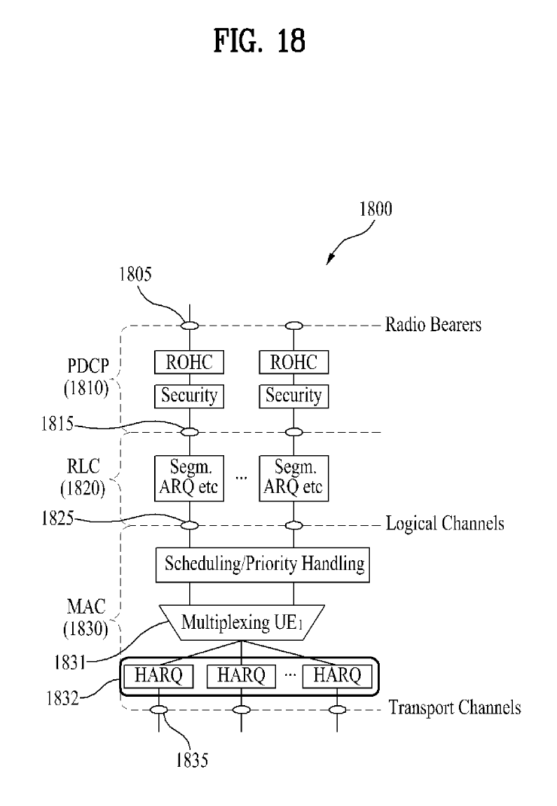

FIG. 17 illustrates the function of a BS processor, especially an L2 (a second layer) structure, to which the exemplary embodiments of the present invention are applied. FIG. 18 illustrates the function of a UE processor, especially an L2 (a second layer) structure, to which the exemplary embodiments of the present invention are applied.

Referring to FIG. 17, a DL L2 structure 1700 includes a PDCP layer 1710, an RLC layer 1720, and a MAC layer 1730. Elements 1705, 1715, 1725, and 1735 indicated by circles at interfaces between respective layers denote service access points (SAPs) for peer-to-peer communication. The SAP 1735 between a physical channel (not shown) and the MAC layer 1730 provides a transport channel. The SAP 1725 between the MAC layer 1730 and the RLC layer 1720 provides a logical channel. A general operation of each layer is as described previously.

The MAC layer 1730 multiplexes a plurality of logical channels (i.e. radio bearers) from the RLC layer 1720. In the structure of a DL L2, a plurality of multiplexing entities 1731 of the MAC layer 1730 is related to application of a multiple input multiple output (MIMO) technique. In a system in which a CA technique is not considered, since one transport channel is generated by multiplexing a plurality of logical channels in the case of non-MIMO, one hybrid automatic repeat and request (HARQ) entity is provided to one multiplexing entity 1731.

Meanwhile, a BS processor considering the CA technique generates a plurality of transport channels corresponding to a plurality of CCs from one multiplexing entity 1731. In the CA technique, one HARQ entity 1732 manages one CC. Therefore, in the MAC layer 1730 of the BS processor supporting the CA technique, a plurality of HARQ entities 1732 is provided to one multiplexing entity 1731 and the MAC layer 1730 performs related operations. Since each HARQ entity 1732 independently processes a transport block, it may simultaneously transmit and receive a plurality of transport blocks through a plurality of CCs.

A UL L2 structure 1800, that is, an L2 structure of a UE processor shown in FIG. 18 performs the same operation as the DL L2 structure shown in FIG. 17, except that one MAC layer 1830 includes one multiplexing entity 1831. Namely, for a plurality of CCs, a plurality of HARQ entities 1832 is provided, the MAC layer 1830 performs operations related to the plurality of HARQ entities 1832, and a plurality of transport blocks is simultaneously transmitted and received through the plurality of CCs.

According to the exemplary embodiments of the present invention as described above, a serving BS or a target BS receives information including a measurement result of a BS prior to handover. Hence, smooth communication after handover may be ensured and thus mobility control of a UE is not affected.

When a CA scheme in which simultaneous communication is performed through a plurality of CCs is applied to the UE, since the serving BS or the target BS receives measurement results of the plurality of CCS prior to handover, the UE may perform rapid communication through the plurality of CCs.

The exemplary embodiment of the present invention of the present invention may be implemented by various means. For example, the exemplary embodiments of the present invention embodiment of the present invention may be implemented by hardware, firmware, software or a combination thereof.

When the method according to the exemplary embodiments of the present invention is implemented using hardware, one or more application specific integrated circuits (ASICs), digital signal processors (DSPs), digital signal processing devices (DSPDS), programmable logic devices (PLDs), field programmable gate arrays (FPGAs), processors, controllers, microprocessors, and the like may be employed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for performing, by a serving base station, a handover operation in a mobile communication system, comprising:
receiving a measurement report including a measurement result of at least one cell from a user equipment;
determining a handover based on the received measurement report; and
transmitting a handover request message to a target base station if the handover is determined, wherein the handover request message includes the measurement result of the at least one cell.

2. The method of claim 1, wherein the measurement result of the at least one cell is included in a radio resource control (RRC) context information element of the handover request message.

3. The method of claim 1, wherein the measurement result of the at least one cell includes a reference signal received power (RSRP) measurement result and a reference signal received quality (RSRQ) measurement result of the at least one cell.

4. The method of claim 1, wherein the measurement result of the at least one cell includes a physical cell identifier of the at least one cell.

5. The method of claim 1, wherein the handover request message further includes carrier frequency information.

6. The method of claim 1, wherein the at least one cell corresponds to at least one component carrier which is aggregated.

7. A method for performing, by a target base station, a handover operation in a mobile communication system, comprising:
receiving a handover request message from a serving base station; and
transmitting a handover request acknowledge message to the serving base station, wherein the handover request message includes a measurement result of at least one cell received from a user equipment.

8. The method of claim 7, wherein the measurement result of the at least one cell is included in a radio resource control (RRC) context information element of the handover request message.

9. The method of claim 7, wherein the measurement result of the at least one cell includes a reference signal received power (RSRP) measurement result and a reference signal received quality (RSRQ) measurement result of the at least one cell.

10. The method of claim 7, wherein the measurement result of the at least one cell includes a physical cell identifier of the at least one cell.

11. The method of claim 7, wherein the handover request message further includes carrier frequency information.

12. The method of claim 7, wherein the at least one cell corresponds to at least one component carrier which is aggregated.

13. A method for performing, by a user equipment, a handover operation in a mobile communication system, comprising:
configuring a measurement report including a measurement result of at least one cell; and
transmitting the configured measurement report, wherein the measurement result of the at least one cell included in the measurement report is included in a handover request message and is transmitted to a target base station from a serving base station.

14. The method of claim 13, wherein the measurement result on the at least one cell is included in a radio resource control (RRC) context information element of the handover request message.

15. The method of claim 13, wherein the measurement result of the at least one cell includes a reference signal received power (RSRP) measurement result and a reference signal received quality (RSRQ) measurement result of the at least one cell.

16. The method of claim 13, wherein the measurement result of the at least one cell includes a physical cell identifier of the at least one cell.

17. The method of claim 13, wherein the handover request message further includes carrier frequency information.

18. The method of claim 13, wherein the at least one cell corresponds to at least one component carrier which is aggregated.
